(19) United States
(12) Patent Application Publication
(10) Pub. No.: US 2006/0021535 A1
(43) Pub. Date: Feb. 2, 2006

(54) Method for printing and aftertreating a print

(75) Inventor: Michael Kaiser, Heidelberg (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/194,783

(22) Filed: Aug. 1, 2005

(30) Foreign Application Priority Data
Jul. 30, 2004 (DE) 10 2004 037 099.0

(51) Int. Cl. B41N 1/00

(52) U.S. Cl. 101/454

(57) ABSTRACT

A method for printing and aftertreating a print includes producing at least one print on a printing material with an ink curable by radiation, and curing the print by the radiation. A level of gloss of the print is set by applying to the print particles matting the surface of the ink. The print is polymerized at depth by at least one radiation source.

### BACKGROUND OF THE INVENTION

Field of the Invention

The invention relates to a method for printing and aftertreating a print, which includes producing the print on a print carrier or print material with an ink curable by radiation.

Prints produced on a print carrier or printing material by inkjet printing with radiation-curing inks have a high level of gloss because of the low viscosity of the inks which are used. If variable information is to be printed by a printing device operating with inkjet printing on a sheet previously printed with offset printing, the highly glossy inkjet imprint then stands out visually clearly from the more matt offset print. In many cases, it is desired that there be no differences or only slight differences in gloss in a print produced by different methods.

Various methods have become known heretofore for influencing the gloss of a print.

A first possible method includes providing a paper which is matt in the unprinted state. If a thin layer thickness is applied during the inkjet printing with radiation-curing inks, the inkjet print on a matt paper then appears with little gloss. The effect of the matt paper diminishes with increasing layer thickness of the inkjet print. If the thickness of the ink layer on the paper is greater than the irregularities in the paper surface, the surface of the paper no longer has any effect upon the extent or level of gloss of the inkjet print. Typical inkjet printing devices produce prints with a layer thickness of more than eight micrometers, so that typical irregularities in the paper surface of less than three micrometers are covered.

Another possible method of influencing the gloss includes covering a print with a varnish. For example, the difference in gloss between prints produced by inkjet printing and by offset printing is reduced by covering the print produced by offset printing with a glossy varnish. Varnishing in accordance with an image is expensive in terms of material and costs. The printing quality of the inkjet print can be impaired, depending upon the varnish that is used. Furthermore, the high gloss of the print is not always desired.

Lamination with a matt color or wholly matt varnishing is a further possible way of equalizing the gloss of prints produced by the inkjet method and by the offset printing method. Lamination and varnishing are additional operations, which make a printed product more expensive.

A further possibility for influencing the gloss is by selecting an ink containing rough microparticles. If light falls on the print produced with such an ink, the light is scattered diffusely, so that the level of gloss is low. In the inkjet print, the size of the particles is restricted by the geometry of nozzles and ink supply ducts. Using particles having the effect of matting the surface of the print because of the size of the particles is therefore virtually impossible in the case of a high halftone or pixel density. In order to be able to implement various levels of gloss, different inks must be used, depending upon the required level of gloss. When changing the ink, a print head must be cleaned quite laboriously, or an additional print head must be provided.

U.S. Pat. No. 5,783,348 discloses a method from the art of electrography for solving the problem of excessive gloss, wherein a toner image is fixed on a print carrier or printing material by a heated ribbon. The ribbon has a structured surface, the structure being imaged on the print after fixing. The ribbon acts as an embossing tool on the toner layer, so that the gloss of the print is reduced. Different levels of gloss require ribbons with different structures.

U.S. Pat. No. 6,409,331 discloses an offset printing method wherein ink droplets are applied to a print transfer material in accordance with an image to a print transfer carrier or printing transfer material. Even before the transfer to a print carrier or printing material, the size and viscosity of the droplets is influenced by UV light radiation, microwaves, heat, chemical methods or airflows. The process of varying or changing the properties of the droplets before the transfer to the print carrier or printing material cannot be controlled accurately because of the interfering variables on the path of the droplets onto the surface of the print carrier or printing material. In particular, temperature and humidity fluctuations have a negative effect upon the print quality.

German Published, Non-Prosecuted Patent Application DE 196 36 391 A1 discloses a method for drying prints produced by inkjet printing, wherein a material printed with UV-curing ink is led past a UV light source and is conveyed between cylinders under pressure. By using the UV light source, the print is dried and cured, respectively, to such an extent that ink droplets on the material are evened out in the nip between the cylinders.

In sheet-fed printing presses, powdering devices have become known heretofore for preventing soiling during transport and when sheets are deposited on a stack. The powder particles are generally applied when the printing ink is no longer liquid but is already wipe resistant. The powder particles lying loosely on a print tend to soil the sheet-fed printing press and interfere with the further processing of the sheets.

In addition to powder, pastes can also be used for preventing the set-off of printing ink. The pastes contain particles which, in a sheet pile or stack, reduce the distance between the sheets. The granular particles in the pastes basically do not react with the printing ink.

### SUMMARY OF THE INVENTION

It is accordingly an object of the invention to provide a method for printing and aftertreating a print, which overcomes the hereinafore-mentioned disadvantages of the heretofore-known methods of this general type and which permits a variable adaptation of the gloss.

With the foregoing and other objects in view, there is provided, in accordance with the invention, a method for printing and aftertreating a print. The method comprises producing the print on a print carrier or printing material with an ink curable by radiation. The print is cured by the radiation. The level of gloss of the print is set by particles matting the surface of the ink being applied to the print. The print is polymerized at depth by at least one radiation source.

In accordance with another mode, the method invention further includes structuring the surface with the particles.

In accordance with a further mode, the method further includes providing the particles in the form of polyamide particles.

In accordance with an added mode, the provided particles have a diameter of more than 5 micrometers.

In accordance with an additional mode, the method further includes applying the particles in accordance with an image.

In accordance with yet another mode, the method further includes, after polymerizing the print, removing excess particles from the surface.

In accordance with yet a further mode, the method further includes matching the level of gloss of the print to the level of gloss of a previously applied print.

In accordance with yet an added mode, the method further includes, after irradiating the print by the radiation source, obtaining, on the print, signals reproducing the gloss of the print. The quantity of particles per unit area of the print is adjusted based upon the measured gloss signals.

In accordance with a concomitant mode, the method further includes providing the radiation source with a capability of emitting ultraviolet light.

Thus, according to the invention, in order to set the level of gloss, matting particles are applied to the still liquid ink. The particles lie on the surface of the film of ink and result in an irregular, matting surface structure. In a further step, the print is polymerized completely by the radiation from a radiation source, in particular an ultraviolet radiation source, so that the surface structure is basically maintained. Particles formed of polyamide with a diameter of more than 5 micrometers are particularly suitable. After the complete polymerization, particles not bound or connected to the print can be removed in a further step. The number of particles introduced into the ink per unit area of the print can be set so that the result is a predefined level of gloss. The level of gloss of a print being processed can be matched to the level of gloss of a print previously applied to a sheet. The quantity of particles introduced per unit area of the print can be controlled based upon the signal from a gloss sensor directed towards the surface of the print. Furthermore, the quantity of particles introduced per unit area can be controlled based upon the consistency and/or viscosity of the ink. A positive secondary effect when polyamide spheres are used is the improved scratch and scuff resistance of the print.

Other features which are considered as characteristic for the invention are set forth in the appended claims.

Although the invention is illustrated and described herein as embodied in a method for printing and aftertreating a print, it is nevertheless not intended to be limited to the details shown, since various modifications and structural changes may be made therein without departing from the spirit of the invention and within the scope and range of equivalents of the claims.

The method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a device for implementing the method for printing and aftertreating a print according to the invention; and

FIGS. 2 to 4 are illustrations relating to forming a three-dimensional surface on a print.

### DESCRIPTION OF THE PREFERRED EMBODIMENTS

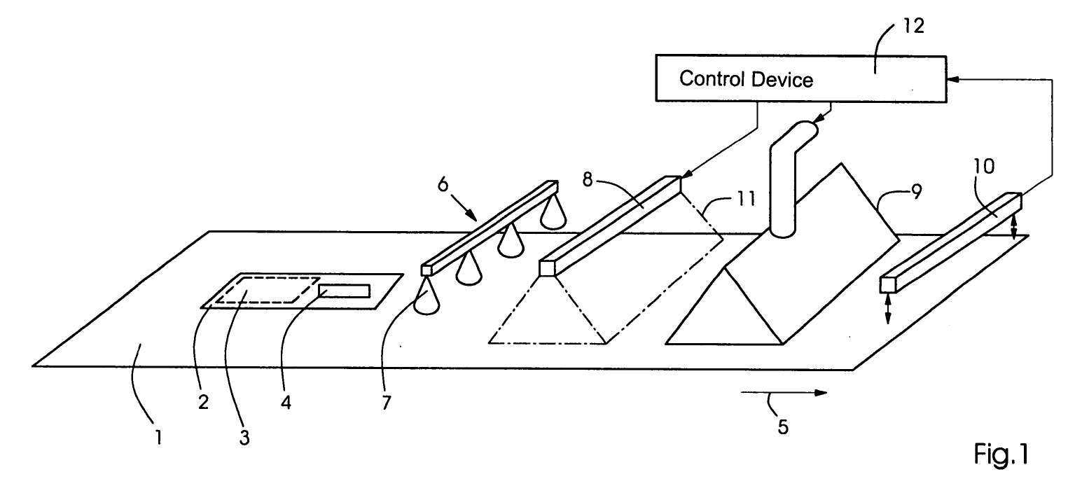

Referring now to the figures of the drawing in detail and first, particularly, to FIG. 1 thereof, there is seen a transport belt 1 for sheets 2 at an outlet from an inkjet device. The sheet 2 has a print 3 thereon previously produced by the offset method and an imprint 4 produced by the inkjet device. In the transport path of the sheets 2, there are provided, in the transport direction 5, a powdering device 6 having powder nozzles 7, a UV radiation source 8, a powder extraction device 9 and a gloss sensor 10. The UV radiation source 8 emits longwave light 11 in the wavelength range of from 300 nm to 400 nm in the direction of the sheets 2 moving past. The powdering device 6, the UV radiation source 8, the powder extraction device 9 and the gloss sensor 10 are connected to a control device 12.

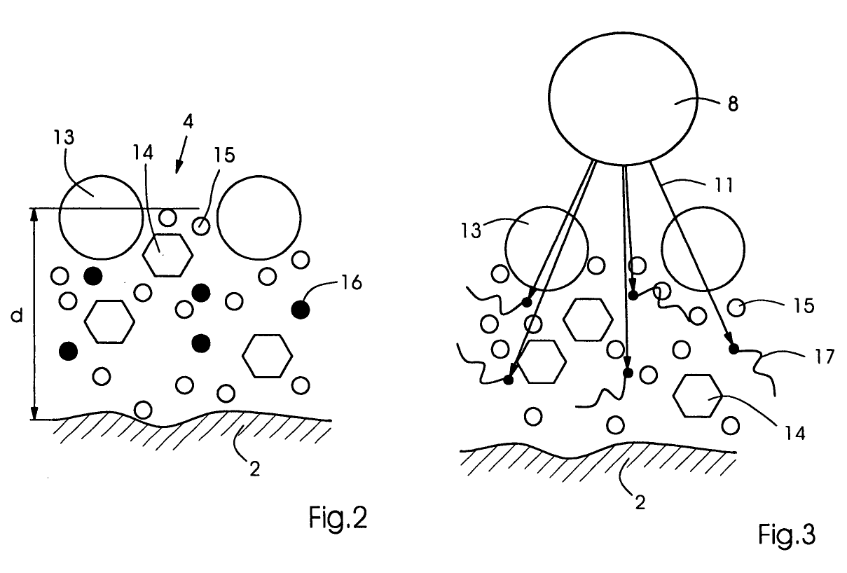

When the sheet 2 on the transport belt reaches the powdering device 6, fine powder particles in the form of polyamide spheres 13 (shown in FIGS. 2, 3 and 4) are blown out of the powder nozzles 7 in the regions on the sheet 2 wherein the still wet imprint 4 is located.

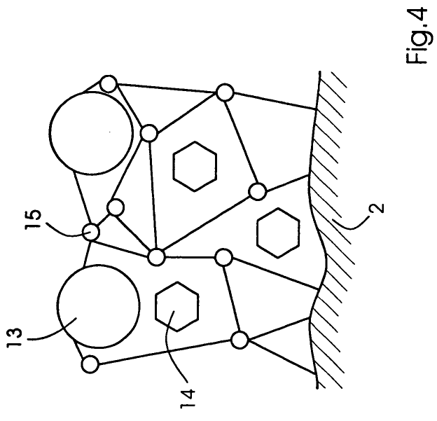

The imprint 4 having a layer thickness d and being freshly produced on the sheet 2, is illustrated in greatly enlarged form in FIG. 2. The imprint 4 is formed of a UV-curing ink having, among other components, colored pigments 14, monomers 15 and photoinitiators 16. The polyamide spheres 13, which have a diameter of more than 5 micrometers, float on the surface of the ink and penetrate partly into the liquid imprint 4. The parts of the polyamide spheres 13 projecting beyond the liquid ink form a three-dimensional structure on the surface of the imprint 4. Once the imprint 4 comes into the active region of the UV radiation source 8, polymerization with the formation of free radicals 17 is then started in the imprint 4, which is illustrated in FIG. 3. In a final state, as shown in FIG. 4, the polyamide spheres 13 are fixed on the surface of the imprint 4. The three-dimensional structure on the surface is maintained, so that daylight is scattered diffusely, as a result of which the surface appears matt. The polyamide spheres 13 which have not been fixed to the surface are removed by the powder extraction device 9. The then actual level of gloss is determined continuously by the gloss sensor 10. The actual level of gloss is compared with a desired or nominal level of gloss, in the control device 12. Upon the occurrence of desired-actual deviations of the level of gloss, the powdering device is adjusted so that more or less polyamide spheres 13 reach the surface of the imprint 4. The level of gloss on the imprint 4 can be controlled in this way. More polyamide spheres 13 per unit area reduce the gloss of the imprint 4. In particular, the level of gloss of the imprint 4 can be matched to the level of gloss of the print 3. It is likewise possible for the level of gloss of the print 3 to be determined by the gloss sensor 10.

The consumption of powder can be reduced if a large number of powder nozzles 7 are provided, having powder ejection quantities which can be adjusted individually by valves. This therefore results in the possibility of applying powder in accordance with an image. If image data is stored in the control device 12, the powder nozzles can then be activated in accordance with the printed image, in particular in accordance with the layer thickness distribution and/or color distribution of the ink. The image data corresponds to the image data of the control device of the inkjet printing device for producing the imprint 4 or can be taken from a raster image processor.

This application claims the priority, under 35 U.S.C. § 119, of German Patent Application 10 2004 037 099.0, filed Jul. 30, 2004; the entire disclosure of the prior application is herewith incorporated by reference.

I claim:

1. A method for printing and aftertreating a print, which comprises:
producing at least one print on a printing material with an ink curable by radiation;
curing the print with the radiation;
setting a level of gloss of the print by applying particles to the print matting a surface of the ink; and
polymerizing the print at depth by at least one radiation source.

2. The method according to claim 1, which further comprises structuring the surface with the particles.

3. The method according to claim 1, which further comprises providing the particles in the form of polyamide particles.

4. The method according to claim 1, wherein the provided particles have a diameter of more than 5 micrometers.

5. The method according to claim 1, which further comprises applying the particles in accordance with an image.

6. The method according to claim 1, which further comprises after polymerizing the print, removing excess particles from the surface.

7. The method according to claim 1, which further comprises matching the level of gloss of the print to a level of gloss of a previously applied print.

8. The method according to claim 1, which further comprises:
after irradiating the print by the radiation source, obtaining, on the print, signals reproducing the gloss of the print; and
adjusting a quantity of particles per unit area of the print based upon the measured gloss signals.

9. The method according to claim 1, which further comprises providing the radiation source with a capability of emitting ultraviolet light.
